(19) United States
(12) Patent Application Publication
(10) Pub. No.: US 2024/0246383 A1
(43) Pub. Date: Jul. 25, 2024

(54) METHOD AND CONTROL DEVICE FOR LEVEL CONTROL OF A MOTOR VEHICLE

(71) Applicant: Dr. Ing. h.c. F. Porsche Aktiengesellschaft, Stuttgart (DE)

(72) Inventors: Markus Eisenbarth, Stuttgart (DE); David Caredda, Ebersbach (DE); Jochen Liebold, Stuttgart (DE)

(73) Assignee: Dr. Ing. h.c. F. Porsche Aktiengesellschaft, Stuttgart (DE)

(21) Appl. No.: 18/514,328

(22) Filed: Nov. 20, 2023

(30) Foreign Application Priority Data
Jan. 25, 2023 (DE) 10 2023 101 752.7

(51) Int. Cl. B60G 17/02; B60G 17/015

(52) U.S. Cl. CPC B60G 17/02; B60G 17/0155; B60G 2202/10; B60G 2400/10; B60G 2500/10; B60G 2500/30

(57) ABSTRACT

A method for level control of a motor vehicle, in which a target value for a floor level of the motor vehicle is calculated from a driving speed and a longitudinal acceleration and/or a lateral acceleration of the motor vehicle. With the aid of an active chassis, a target value for a lower floor level is provided at a higher longitudinal acceleration and/or lateral acceleration and a target value for a higher floor level is provided at a lower longitudinal acceleration and/or lateral acceleration. Dynamically adjusting the floor level to different acceleration situations of the motor vehicle enables a motor vehicle with a high level of driving safety and good driving comfort.

### CROSS-REFERENCE TO RELATED APPLICATION

This application claims priority to German Patent Application No. 10 2023 101 752.7, filed Jan. 25, 2023, the content of such application being incorporated by reference herein in its entirety.

### FIELD OF THE INVENTION

The invention relates to a method and a control device with the aid of which a floor level of a motor vehicle can be regulated. The invention also relates to a motor vehicle comprising such a control device and to a use of such a method.

### BACKGROUND OF THE INVENTION

From DE 10 2004 015 651 A1, which is incorporated by reference herein, it is known that changing damping when controlling the level of a motor vehicle is taken into account in the expected transient response around a specified target value for the floor level of the motor vehicle. In motor vehicles, there is a constant need to achieve a high level of driving safety and good driving comfort.

### SUMMARY OF THE INVENTION

Described herein are measures that enable a motor vehicle with a high level of driving safety and good driving comfort.

One aspect of the invention relates to a method for level control of a motor vehicle is provided, in which a target value for a floor level of the motor vehicle is calculated from a driving speed and a longitudinal acceleration and/or a lateral acceleration of the motor vehicle, wherein, with the aid of an active chassis, a target value for a lower floor level is provided at a higher longitudinal acceleration and/or lateral acceleration and a target value for a higher floor level is provided at a lower longitudinal acceleration and/or lateral acceleration.

It has been found that, in the various situations that occur when a motor vehicle is driving, it can be useful for the floor levels of the motor vehicle to be different. Instead of providing a specific floor level via a manual adjustment and/or by setting a specific driving mode as a constant target value, the target value for the floor level of the motor vehicle is dynamically adapted to current driving situations. This takes into account the fact that, when cornering at a specific driving speed, correspondingly high lateral forces act on the wheels, which can lead to skidding. If a correspondingly high lateral acceleration is measured, however, the target value for the floor level is automatically reduced so that the center of gravity of the motor vehicle is lowered and the tires of the wheels have better grip. This increases driving safety. It also takes into account that the front of the motor vehicle may lift during strong acceleration and dip during hard braking. If a correspondingly high longitudinal acceleration is measured, however, the target value for the floor level is automatically reduced so that the center of gravity of the motor vehicle is lowered and the tires of the wheels have better grip, so that spinning of the wheels when accelerating and skidding of the wheels when braking is avoided. This increases driving safety. If no critical lateral and/or longitudinal accelerations are measured, a previously initiated lowering of the floor level can be reversed and/or, at least at driving speeds significantly below the maximum speed, the originally provided target value for the floor level can be increased. Unnecessary wear of the tires of the wheels and an unnecessarily hard suspension of the chassis with only a small spring travel can thus be avoided, as a result of which driving comfort is improved. Dynamically adjusting the floor level to different acceleration situations of the motor vehicle enables a motor vehicle with a high level of driving safety and good driving comfort.

The change in the floor level can be achieved with the aid of the active chassis, which, in order to be able to maintain a specified target value for the floor level as accurately as possible, even when the road surface is uneven, can have its own control loop. The active chassis can be an adaptive chassis, a semi-adaptive chassis, a slow-active system or an active system. The adaptive chassis typically comprises a spring strut for each wheel, via which said wheel is connected to the body of the motor vehicle. The spring strut can comprise a damper-spring system, in which springs and dampers can be connected in parallel and/or in series. The length of the spring strut of the adaptive chassis can be changed to change the floor level of the motor vehicle, i.e., a distance between the body of the motor vehicle and an underlying surface. For this purpose, a support point of a spring, in particular an air spring, can be displaced along the direction of the spring force, as a result of which the spring becomes stiffer and only able to compress over a smaller spring travel when the floor level is lowered. Additionally or alternatively, a damper, which is connected in series or in parallel to the (air) spring and the damping force of which is variable, can be provided. The damping force can be used to influence how much the air spring can compress, so that the target value for the floor level can also be influenced by changing the damping force. It is particularly preferably provided that the control of the active chassis uses the damping force as a control variable for the to-be-set floor level of the motor vehicle.

The driving speed of the motor vehicle is usually known in a vehicle control system for display in a speedometer anyway and can easily be used to control the floor level. The longitudinal acceleration and/or the lateral acceleration can be measured by acceleration sensors, wherein a longitudinal acceleration and/or a lateral acceleration is preferably measured for each individual wheel.

It is in particular provided that a pitching and/or rolling tendency of the motor vehicle is calculated from the longitudinal acceleration and/or the lateral acceleration of the motor vehicle and, for each individual wheel of the motor vehicle, a target value for the floor level of the motor vehicle that can be controlled by the active chassis is changed in such a way that pitching and/or rolling of the motor vehicle is substantially compensated. Pitching and/or rolling of the motor vehicle can be compensated by using a target value for the floor level for each wheel individually that can differ from other target values of other wheels. In the event of hard braking, for example, in which a lowering of the front of the motor vehicle is to be feared, which corresponds to a pitching movement, the target value for the floor level of the front wheels that would otherwise have a greater spring compression can be increased and the target value for the floor level of the otherwise skidding rear wheels can be reduced, so that the vehicle pitches to a smaller extent and/or remains level to a larger extent.

An average target value for the floor level of all of the wheels preferably corresponds substantially to the target value for the floor level when the motor vehicle is traveling straight ahead without acceleration. A floor level for the motor vehicle provided for other reasons is thus substantially maintained. In the actual or theoretical case that pitching and rolling is fully compensated, the body of the motor vehicle would be substantially parallel to the underlying surface at a floor level that is actually intended for unaccelerated straight-ahead travel of the motor vehicle.

For each wheel, the active chassis particularly preferably comprises a spring strut, in particular one which comprises an air spring, wherein a damping force acting on the respective spring strut is adjusted to change the target value for the floor level. The spring strut can comprise a spring and a damper that form a damper-spring system. The damping force can be used to influence how much the air spring can compress, so that the target value for the floor level can also be influenced by changing the damping force. It is particularly preferably provided that the control of the active chassis uses the damping force as a control variable for the to-be-set floor level of the motor vehicle.

In particular only the damping force acting on the respective spring strut is adjusted to change the target value for the floor level. The floor level can thus be changed particularly easily and particularly quickly.

An extent of an unevenness of a road surface is preferably acquired for the motor vehicle with the aid of an in particular forward-looking road profile detection, wherein, in the event of a greater unevenness of the road surface, the target value for the floor level of the motor vehicle is corrected to a target value for a higher floor level. If the road profile detection detects a bump, a curb, an obstacle or some other elevation, the current target value for the floor level can be raised in such a way that the body of the motor vehicle does not hit said obstacle. Damage to the underbody of the motor vehicle can be avoided.

It is particularly preferably determined over a specified observation period for which time periods a lower target value for the floor level was provided as a result of detected longitudinal accelerations and/or lateral accelerations and, if the sum of these time periods exceeds a specified limit time period, the target value for the floor level is corrected to a target value for a higher floor level. If strong longitudinal and/or lateral accelerations are measured particularly frequently, for example due to a particularly winding route, the motor vehicle would be at a low floor level for a particularly long period of time. In this case, however, it can be assumed that the high acceleration values are not an isolated exceptional situation. The driver is familiar with the current conditions after the observation period, so that reducing the grip somewhat in order to reduce wear on the tires of the wheels is justified.

Another aspect of the invention relates to a control device for operating an active chassis of a motor vehicle, comprising an input port for reading in a driving speed and a longitudinal acceleration and/or a lateral acceleration of the motor vehicle and an output port for controlling a spring strut connected to a respective wheel of the motor vehicle and a computing unit, wherein the computing unit is configured to carry out the method which can be designed and further developed as described above. Dynamically adjusting the floor level to different acceleration situations of the motor vehicle with the aid of the control device enables a motor vehicle with a high level of driving safety and good driving comfort.

Another aspect of the invention relates to a motor vehicle comprising an active chassis which acts on wheels, a control device, which can be designed and further developed as described above, for operating the active chassis, a speed sensor which communicates with the control device for detecting a driving speed of the motor vehicle, a longitudinal acceleration sensor which communicates with the control device for detecting a longitudinal acceleration of the motor vehicle and a lateral acceleration sensor which communicates with the control device for detecting a lateral acceleration of the motor vehicle. Dynamically adjusting the floor level to different acceleration situations of the motor vehicle enables a motor vehicle with a high level of driving safety and good driving comfort.

Another aspect of the invention relates to a use of the method, which can be designed and further developed as described above, for correcting a standard target value for the floor level of the motor vehicle determined for unaccelerated straight-ahead travel. The method according to aspects of the invention is thus not used instead of another method for level control of a motor vehicle, but in addition to the other method for level control of a motor vehicle in order to be able to intervene in the target value for the floor level specified by the other method in critical driving situations that require better grip of the wheels for improved driving safety. Dynamically adjusting the floor level to different acceleration situations of the motor vehicle enables a motor vehicle with a high level of driving safety and good driving comfort.

### BRIEF DESCRIPTION OF THE DRAWINGS

The invention will be explained in the following by way of example with reference to the accompanying drawings and using preferred embodiment examples, wherein the features presented below can constitute an aspect of the invention either individually or in combination. The figures show:

FIG. 1 depicts a schematic model for a first active chassis for carrying out the method for level control of a motor vehicle, and

FIG. 2 depicts a schematic model for a second active chassis for carrying out the method for level control of a motor vehicle.

### DETAILED DESCRIPTION OF THE INVENTION

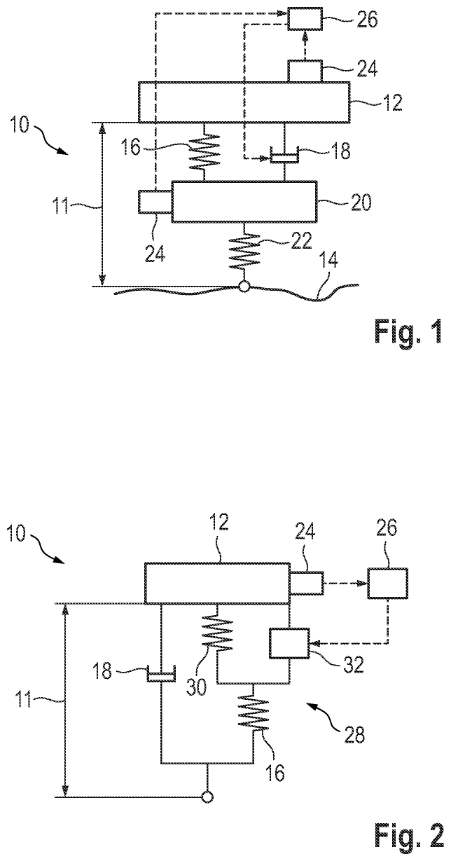

The active chassis 10 shown as a model in FIG. 1 can be used in a method for level control of a motor vehicle to dynamically adjust a floor level 11 of a body 12 of the motor vehicle in relation to an underlying surface or road surface 14 to current driving situations. The body 12 is coupled via a spring strut comprising a spring 16 and a damper 18 to a wheel 20, which rolls on the road surface 14 with a spring action with its elastic tire 22. A sensor system 24 connected to the wheel 20 and/or the body 12 can measure a driving speed of the motor vehicle as well as a longitudinal acceleration and a lateral acceleration of the motor vehicle, wherein these measurements can in particular additionally or alternatively be measured individually for each wheel 20 of the motor vehicle. The measurement data of the sensor system 24 is supplied to a control device 26 via an input port. From the measurement data that describes a current dynamic driving situation of the motor vehicle, the control device 26 calculates a target value for the floor level 11, in particular in order to lower the floor level 11 in a driving situation which, due to high acceleration values, requires a particularly good grip of the tires 22. For this purpose, the control device 26 can induce the active chassis 10 to set a new target value for the floor level 11 via an output port, preferably for each wheel 20 individually. In particular if the spring 16 is configured as an air spring, this can easily be achieved by changing a damping force in the damper 18. For this purpose, a damper fluid is added or partially drained, for example, to change the damper properties and/or the end stops of the damper 18 and thus also the floor level 11.

As shown in FIG. 2, a damper-spring system 28 can be connected in series in addition or as an alternative to the spring 16, wherein the damper-spring system 28 can comprise a further spring 30 and a servomotor 32 or a further damper in addition to or instead of the servomotor 32. To set the floor level 11, the control device 26 can act on the servomotor 32, which can thus change the extension of the damper-spring system 28 to actuate a new target value for the floor level.

The values (e.g., higher floor level, lower floor level, greater unevenness, etc.) described herein may be relative values, and relative to either each other or either a pre-determined or pre-defined value.

It is to be understood that the operational steps described herein may be performed by a controller upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller described herein is implemented in software code or instructions which are tangibly stored on a tangible computer readable medium. Upon loading and executing such software code or instructions by the controller, the controller may perform any of the functionality of the controller described herein, including any steps of the methods described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

What is claimed is:

1. A method for level control of a motor vehicle having an active chassis, said method comprising:
calculating a target value for a floor level of the motor vehicle based on a driving speed and a longitudinal acceleration and/or a lateral acceleration of the motor vehicle,
said calculating step comprising providing the target value for a lower floor level at a higher longitudinal acceleration and/or lateral acceleration, and
said calculating step comprising providing the target value for a higher floor level, as compared with the lower floor level, at a lower longitudinal acceleration and/or lateral acceleration.

2. The method according to claim 1, further comprising calculating a pitching and/or rolling tendency of the motor vehicle based on the longitudinal acceleration and/or the lateral acceleration of the motor vehicle, and
for each individual wheel of the motor vehicle, a target value for the floor level of the motor vehicle that can be controlled by the active chassis is changed in such a way that pitching and/or rolling of the motor vehicle is substantially compensated.

3. The method according to claim 2, in which an average target value for the floor level of all of the wheels corresponds substantially to the target value for the floor level when the motor vehicle is traveling straight ahead without acceleration.

4. The method according to claim 1, in which, for each wheel, the active chassis comprises a spring strut including an air spring, wherein a damping force acting on the respective spring strut is adjusted to change the target value for the floor level.

5. The method according to claim 4, in which only the damping force acting on the respective spring strut is adjusted to change the target value for the floor level.

6. The method according to claim 1, further comprising acquiring an unevenness of a road surface for the motor vehicle with the aid of a forward-looking road profile detection, wherein, in the event of a greater unevenness of the road surface, the target value for the floor level of the motor vehicle is corrected to the target value for the higher floor level.

7. The method according to claim 1, in which it is determined over a specified observation period for which time periods a lower target value for the floor level was provided as a result of detected longitudinal accelerations and/or lateral accelerations and, if the sum of these time periods exceeds a specified limit time period, the target value for the floor level is corrected to the target value for the higher floor level.

8. Use of the method according to claim 1 for correcting a standard target value for the floor level of the motor vehicle determined for unaccelerated straight-ahead travel.

9. A control device for operating an active chassis of a motor vehicle, said control device comprising an input port for receiving a driving speed and a longitudinal acceleration and/or a lateral acceleration of the motor vehicle and an output port that is connected for controlling a spring strut connected to a respective wheel of the motor vehicle and a computing unit, wherein the computing unit is configured to:
calculate a target value for a floor level of the motor vehicle based on a driving speed and a longitudinal acceleration and/or a lateral acceleration of the motor vehicle,
provide a target value for a lower floor level at a higher longitudinal acceleration and/or lateral acceleration, and
provide a target value for a higher floor level, as compared with the lower floor level, at a lower longitudinal acceleration and/or lateral acceleration.

10. A motor vehicle comprising an active chassis which acts on wheels of the motor vehicle, the control device according to claim 9 for operating the active chassis, a speed sensor which communicates with the control device for detecting a driving speed of the motor vehicle, a longitudinal acceleration sensor which communicates with the control device for detecting a longitudinal acceleration of the motor vehicle and a lateral acceleration sensor which communicates with the control device for detecting a lateral acceleration of the motor vehicle.
